(19) United States
(12) Patent Application Publication
(10) Pub. No.: US 2012/0089946 A1
(43) Pub. Date: Apr. 12, 2012

(54) CONTROL APPARATUS AND SCRIPT CONVERSION METHOD

(76) Inventor: Takayuki FUKUI, Osaka (JP)

(21) Appl. No.: 13/329,680

(22) Filed: Dec. 19, 2011

Related U.S. Application Data
(63) Continuation of application No. PCT/JP2011/003589, filed on Jun. 23, 2011.

(30) Foreign Application Priority Data
Jun. 25, 2010 (JP) 2010-145407

(51) Int. Cl. G06F 3/048

(52) U.S. Cl. 715/822

(57) ABSTRACT

A control apparatus includes: a display unit which is smaller than a display unit of a control target apparatus in display area; an operating unit which receives an input via an operation screen displayed on the display area of the display unit; a script receiving unit obtaining, from the control target apparatus, a script which defines GUI receiving the input via the operation screen displayed on the one-screen display area of the control target apparatus; and a script converting unit converting the script into another script such that the converted script defines a GUI component to be displayed on the display unit in an operable manner, the GUI component being allocated on the operation screen of the GUI defined by the obtained script. The display unit displays the operation screen of the control target apparatus based on the converted script.

### CROSS REFERENCE TO RELATED APPLICATIONS

This is a continuation application of PCT Patent Application No. PCT/JP2011/003589 filed on Jun. 23, 2011, designating the United

States of America, which is based on and claims priority of Japanese Patent Application No. 2010-145407 filed on Jun. 25, 2010. The entire disclosures of the above-identified applications, including the specifications, drawings and claims are incorporated herein by reference in their entirety.

### BACKGROUND OF THE INVENTION

(1) Field of the Invention

The present invention relates to a technique to optimally display an operation screen of a control target apparatus on a display unit of a control apparatus when a user remotely controls the control target apparatus via a network.

(2) Description of the Related Art

The improvement in home networking has diffused the use of applications for remotely controlling specific functions between apparatuses through the network. Due to the recent diversification of network-connected apparatuses, such applications inevitably require users to have extra works and cause inconvenience to the users because the applications develop drawbacks such that preparing an application for each function is inefficient and the firmware of the apparatuses needs to be updated to meet new functions.

Conventional function-independent remote control techniques include a client-server technique employing scripting languages, such as the Hyper Text Markup Language (HTML) and JavaScript (trademark). This technique allows a client apparatus; namely a commanding apparatus, to remotely control a server apparatus; namely a commanded apparatus.

In addition, Patent Literature 1 (See Japanese Unexamined Patent Application Publication No. 2005-341041) discloses a technique to change to present a display image according to the size of the screen of a control apparatus.

Compared to stationary apparatuses, mobile apparatuses including a digital camera and a portable audio player have a smaller screen than that of the stationary apparatuses. Furthermore, some smart phones are operated via a touch panel. Thus, if all the commanding apparatuses use the same scripting language for remote control, some of the apparatuses will cause deteriorating visibility and operability. The following exemplary problems develop when the user try to display an operation screen of a TV on the display unit of a cellular phone: Letters become too small to read, and space between selection buttons becomes so narrow that, when the user pressed a button, he or she would inadvertently press a neighboring wrong button.

The present invention is conceived in view of the above problems and has an object to provide a control apparatus and a script conversion method which are capable of displaying an excellent screen suitable to the display capability and an operation procedure of a control target apparatus, even though the control apparatus and the control target apparatus are different in display capability and operation procedure.

### SUMMARY OF THE INVENTION

In order to solve the above problems, a control apparatus according to an aspect of the present invention includes: an obtaining unit which obtains screen display operational information on a control target apparatus; an operating unit which receives an input from a user; a converting unit which converts the screen display operational information such that the screen display operational information conforms to an input method of the operating unit; and a display unit which displays a screen formed based on the converted screen display operational information.

This structure allows the control apparatus to convert the screen display operational information according to the input method of the operating unit. Thus, the control apparatus can change the script that is the screen display operational information, such that (i) in the case where the operating unit is a touch screen, a selectable area is highlighted as a selection button with a frame and (ii) in the case where the operating unit is a pointing device, a selection button is highlighted with a frame when the pointer is on the selectable area.

The control apparatus executes the converted screen display operational information to display an excellent operation screen which suits various input methods of operating units.

It is noted that, instead of an apparatus, the present invention may also be provided as (i) an integrated circuit including processing units which the apparatus has (ii) a method which implements the processing units included in the apparatus as steps (iii) a program causing a computer to execute the steps, and (iv) information, data, and a signal showing the program. The program, program, information, data, and signal may be distributed via a recording medium such as a Compact Disc-Read Only (CD-ROM), and a communications medium such as the Internet.

The present invention makes it possible to provide an optimum screen display which suits to the display capability and an operation procedure of a control target apparatus, even though the control apparatus and the control target apparatus are different in display capability and operation procedure. Accordingly, the user can remotely control the control target apparatus without losing an operational feeling.

### BRIEF DESCRIPTION OF THE DRAWINGS

These and other objects, advantages and features of the invention will become apparent from the following description thereof taken in conjunction with the accompanying drawings that illustrate a specific embodiment of the present invention. In the Drawings:

FIG. 1 shows a structure of a remote user interface (UI) system according to the embodiment of the present invention;

FIG. 2 depicts a block diagram showing a structure of a control apparatus according to the embodiment of the present invention;

FIG. 3 depicts a block diagram showing a structure of a control target apparatus according to the embodiment of the present invention;

FIG. 4 shows in (a) and (b) an exemplary screen display before and after script conversion according to the embodiment of the present invention;

FIG. 5 shows in (a) and (b) another exemplary screen display before and after script conversion according to the embodiment of the present invention;

FIG. 6 depicts a flowchart showing a procedure of the script conversion for displaying the operation screen in (b) in FIG. 5;

FIG. 7 shows in (a) and (b) an exemplary operation screen before and after script conversion executed to have fewer graphical user interface (GUI) components when the operation screen displays, as a priority, GUI components closer to the GUI component selected by default; and

FIG. 8 shows in (a) and (b) an exemplary operation screen before and after script conversion for reducing the number of GUI components when the operation screen displays GUI components found in a criss-cross direction as a priority.

### DESCRIPTION OF THE PREFERRED EMBODIMENT

Described hereinafter is an embodiment of the present invention including an electronic appliance system.

### Embodiment

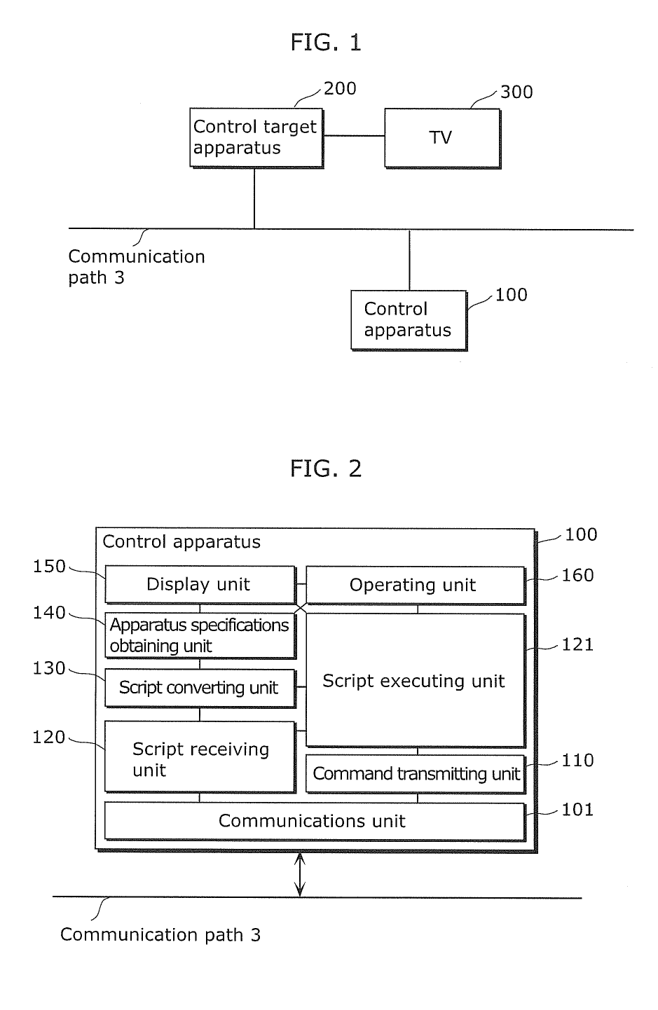

FIG. 1 shows a structure of a remote UI system according to the embodiment of the present invention.

In FIG. 1, the remote UI system according to the embodiment includes a control apparatus 100, a control target apparatus 200, a TV 300 and a communication path 3. The control apparatus 100 is connected to the control target apparatus 200 via the communication path 3, and remotely controls the control target apparatus 200. The TV 300 is connected to the control target apparatus 200 via a connecting line for, such as, the High-Definition Multimedia Interface (HDMI), and works as a display unit for the control target apparatus 200. For example, the control apparatus 100 includes devices such as a cellular phone, a personal digital assistance (PDA), and a remote controller for TV. These devices store in their memory Java Script executing the script conversion according to the embodiment.

FIG. 2 depicts a block diagram showing a structure of control apparatus 100 according to the embodiment of the present invention.

In FIG. 2, the control apparatus 100 includes the following units: a communications unit 101 for holding communication with the communication path 3; a script receiving unit 120 for receiving a script from the control target apparatus 200 via the communications unit 101, a command transmitting unit 110 for transmitting, based on an order of the script, a command to the control target apparatus 200 via the communications unit 101, an apparatus specifications obtaining unit 140 which obtains the information on the control apparatus 100 in executing the received script, such as display unit information on the display unit 150 and input method information on an operating unit 160; a script converting unit 130 for converting the script based on the information which the apparatus specifications obtaining unit 140 obtains, such as the size of a display area of the control apparatus 100 and the input method information; and a script executing unit 121 for executing the script converted by the script converting unit 130.

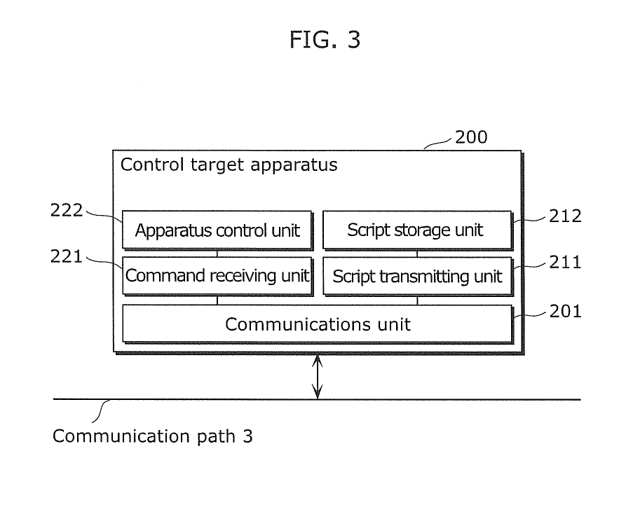

FIG. 3 depicts a block diagram showing a structure of a control target apparatus 200 according to the embodiment of the present invention. The control target apparatus 200 includes: a script storage unit 212 for storing a script in which the graphical user interface (GUI) of the control target apparatus 200 is described; a communicating unit 201 for holding communication with the control apparatus 100 connected with the control target apparatus 200 via the communication path 3; a script transmitting unit 211 for transmitting the script stored in the script storage unit 212 to the control apparatus 100 via the communicating unit 201; a command receiving unit 221 for receiving a command which is transmitted from the control apparatus 100 when the operation screen is operated and the script is executed; and an apparatus control unit 222 for controlling operations of the control target apparatus 200 in response to the received command.

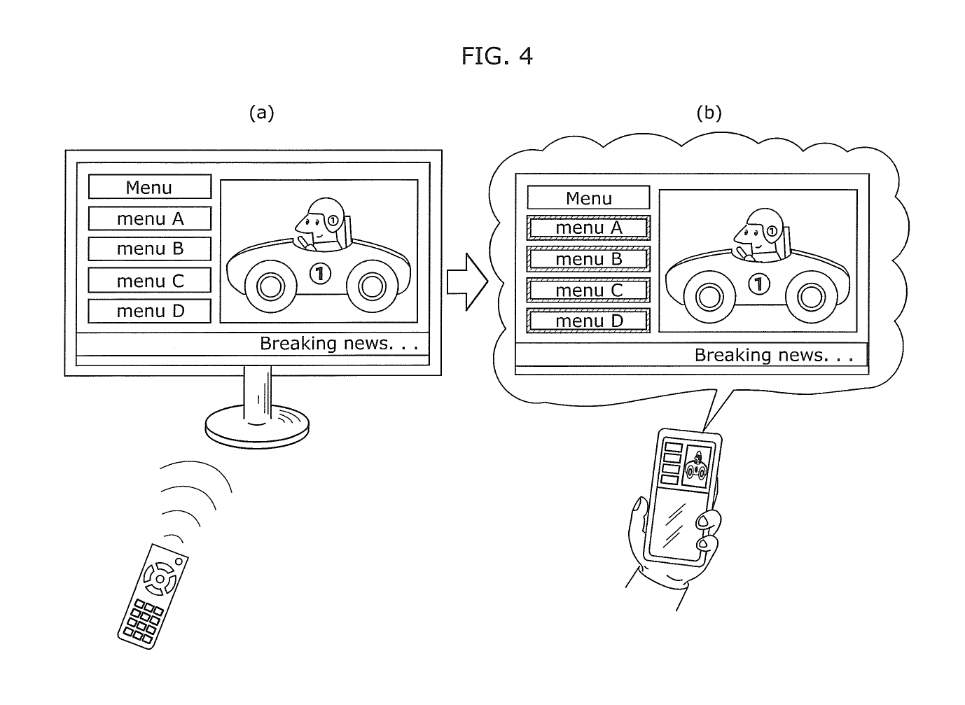

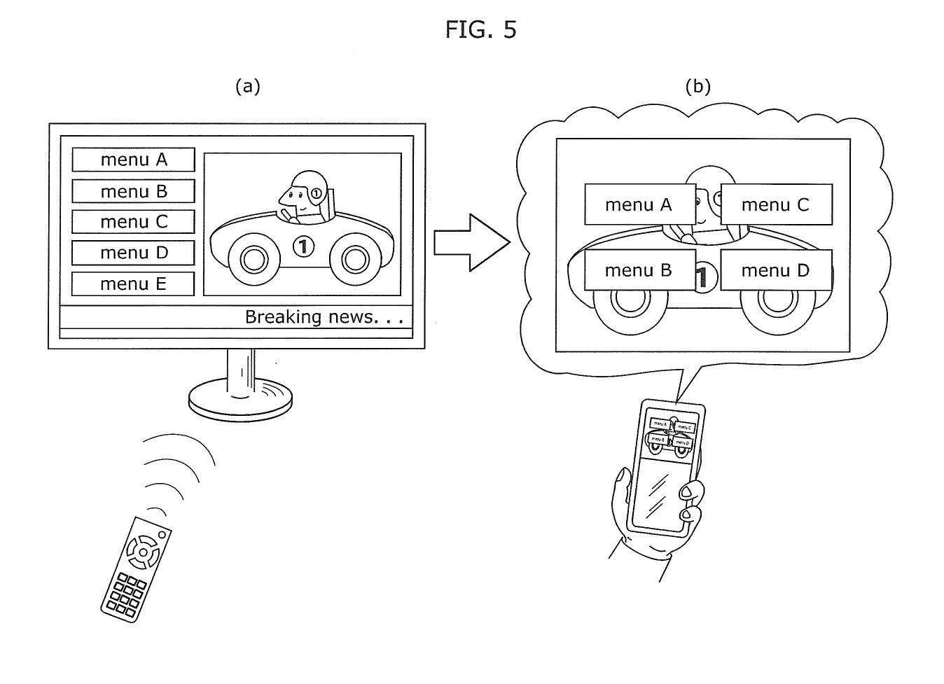

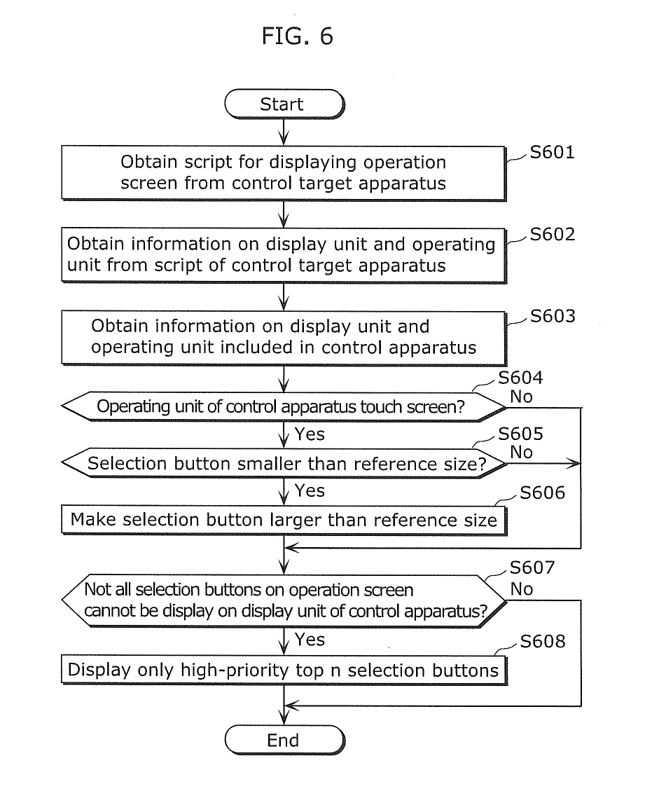

FIGS. 4 and 5 show in (a) and (b) exemplary screen displays before and after script conversion according to the embodiment of the present invention. FIG. 6 depicts a flowchart showing a procedure of the script conversion for displaying the operation screen in (b) in FIG. 5.

Before using the remote UI, the user of the control apparatus 100 registers the apparatus ID of the control apparatus 100 in the control target apparatus 200 to obtain a script from the control target apparatus 200 (S601),In other words, upon receiving a script transmission request from the control apparatus 100, the script transmitting unit 211 in the control target apparatus 200 causes the communicating unit 201 to transmit the script stored in the script storage unit 212 to the control apparatus 100 via the communication path 3. Furthermore, in the control apparatus 100, the script receiving unit 120 receives the script transmitted by the control target apparatus 200 via the communications unit 101.

The script includes screen information and operational information of the control target apparatus 200. The script converting unit 130 obtains the screen information and the operational information out of the received script (S602).The screen information shows the size of a display area of the display unit (the TV 300 or an external monitor, for example) on which the control target apparatus 200 shows the operation screen. The operational information shows whether or not the control target apparatus 200 has a touch screen.

Here, the apparatus specifications obtaining unit 140 inquires of the display unit 150 and the operating unit 160 for their specifications. Through the inquiries, the apparatus specifications obtaining unit 140 obtains the display unit information on the display unit 150 and the input method information on the operating unit 160 (S603).

Suppose the control apparatus 100 is a portable apparatus having a small screen display area. The script converting unit 130 interprets the received script to determine whether or not the operation screen of the control target apparatus 200 fits into the display unit 150 of the control apparatus 100 in one screen. In the case where the operation screen shown in the received script does not fit in one screen, the script converting unit 130 resizes the operation screen such that the operation screen fits into the display unit 150.

Then, the script converting unit 130 determines whether or not the operating unit 160 employs a touch screen style according to the input method information on the operating unit 160 obtained by the apparatus specifications obtaining unit 140 (S604). Here, the control apparatus 100 operates itself and another apparatus through a touch screen. The script converting unit 130 determines whether or not a selection button appearing on the resized operation screen is smaller than a reference size (S605). Here, the reference size of a selection button is a large enough for the user to recognize which button has been pressed in pressing a selection button with his or her finger. Specifically, suppose the case where two or more selection buttons appear on an area of contact between the touch screen and a finger tip. The user inadvertently presses the two or more buttons at a time, and cannot tell on the touch screen which selection button has been pressed. Thus, in an apparatus equipped with a touch screen, each of selection buttons has a minimum required reference size predetermined when the selection buttons are displayed. Together with the information showing that the input method is a touch screen style, the reference size is stored in the operating unit 160 or read-only memory (ROM) of the operating unit 160 as the input method information on the operating unit 160.

In the case where the selection button is smaller than the reference size, the script converting unit 130 changes the script such that each of the selection buttons is equal to or larger than the reference size (S606).

It is noted that the script converting unit 130 checks whether or not the selection button is in the minimum required size; that is, whether or not the selection button is equal to or larger than the reference size, only in the case where the operating unit 160 employs a touch screen style as the input method. When the selection button is smaller than the reference size, the script converting unit 130 changes the script such that the selection button becomes larger than the reference size; however, adjustment in size of appearance shall not be limited to the selection button on the touch screen. For example, when the operation screen of the control target apparatus 200 is resized to fit in the display unit 150 of the control apparatus 100, the size of a character appearing on the operation screen may be adjusted such that the character size is not smaller than a predetermined size. The predetermined size is the minimum required size for the user to be able to see the character on the resized operation screen. Such a predetermined size may be preset by a manufacturer of the control apparatus 100 or may be designated by the user. For example, the predetermined size may be a font size for e-mail texting.

Then, the script converting unit 130 interprets the changed script to double-check whether or not the operation screen can fit on the display unit 150 of the control apparatus 100 in one screen (S607). In the case where the operation screen cannot be displayed in one screen, the script converting unit 130 displays only n selection buttons displayable on the display unit 150 of the control apparatus 100. Specifically, the script converting unit 130 changes the script according to the priority of the selection buttons such that only the top n selection buttons are to be displayed (S608). FIG. 5 is an exemplary screen display. FIG. 5 shows in (a) an exemplary operation screen when the script-executing apparatus is the control target apparatus 200 having an operating unit which is (i) in the form of a TV remote control and (ii) equipped with directional buttons and an enter button. In comparison to (a) in FIG. 5, (b) in FIG. 5 shows an exemplary display of selection buttons on the operation screen when the script-executing apparatus is an apparatus having a touch-screen operating unit as the control apparatus 100 has. When each of the selection buttons is resized larger than the reference size in the case where the operation screen is small as shown on the control apparatus 100 in (b) in FIG. 5, it is often difficult to display the operation screen in one screen on the display area of the display unit 150. In this case, the control apparatus 100 according to the embodiment displays only selection buttons “menu A” to “menu B” as shown in (b) in FIG. 5, for example, and does not display a selection button “menu E” displayed on the operation screen in (a) in FIG. 5. The selection buttons “menu A” to “menu D” are determined by, for example, the script in which the operation screen in (a) in FIG. 5 is described. Here, the script extracts the top n (n =4, for example) high-priority selection buttons. A higher priority is assigned to a selection button closer to, for example, a default position of the cursor. On the operation screen of the control target apparatus 200 in (a) in FIG. 5, for example, suppose the case where the selection button on the top is positioned at the default position of the cursor. The top four high-priority selection buttons to be extracted are the selection buttons “menu A” to “menu D”.

Described below is how to determine whether or not the operation screen can fit in one screen. In most cases, the display units of the control target apparatus 200 and the control apparatus 100 differ with each other in display aspect ratio. Thus, first, the script converting unit 130 arranges all the selection buttons appearing one operation screen at all available positions, and calculates the size of an area required to display all the selection buttons. Suppose, for example, that each of the selection buttons appearing on the operation screen is in the reference size. When (i) the selection buttons are arranged at the positions defined by the received script as shown in (a) in FIG. 5 and (ii) the selection buttons are arranged at new positions as shown in (b) in FIG. 5, the script converting unit 130 calculates the width and the height of an area required to display the selection buttons. In the case where the calculated width and height are smaller than those of the display unit 150, the display unit 150 can be used with no problem. In contrast, in the case where either the height or the width of the area required to display the selection buttons is greater than the height or the width of the display unit 150 of the control apparatus 100, the script converting unit 130 determines that the operation screen cannot fit in one screen. Regarding a variation on an arrangement of the selection buttons, the script converting unit 130 compares the width and the height of an area to be required to display the selection buttons with those of the display unit 150 for any possible arrangement, not limited to the arrangement in (b) in FIG. 5. Based on the comparison, the script converting unit 130 determines whether or not the operation screen fits in one screen.

In the case where the result of the double check in Step S607 shows that the operation screen after the script conversion fits on display unit 150 of the control apparatus 100 in one screen, the script converting unit 130 ends the process.

It is noted that, instead of ending the process, the script converting unit 130 may, for example, change the script such that the script highlights an area to be selectable as a selection button for the user with the operating unit 160. The changed script is informed of the script executing unit 121, and executed. The operation screen is displayed on the display unit 150. The user operates the operation screen, using the operating unit 160.

FIG. 4 shows in (a) an exemplary operation screen when the script-executing apparatus is the control target apparatus 200 having an operating unit which is (i) in the form of a TV remote control and (ii) equipped with directional buttons and an enter button. In comparison to (a) in FIG. 4, (b) in FIG. 4 shows an exemplary display of selection buttons on the operation screen when the script-executing apparatus is an apparatus having a touch-screen operating unit as the control apparatus 100 has. When the user gives input on a TV remote control as shown in (a) in FIG. 4, the curser is moved only to a selectable button even though the user cannot tell which button is selectable. Thus, no problem develops in particular. In contrast, the touch-screen operating unit in (b) in FIG. 4 does not display the cursor, and it is difficult for the user to tell which button is selectable. If there is no sign to show the user which selection button is selectable, the user would inadvertently press an unselectable button. Thus, as shown in (b) in FIG. 4, for example, the outline of a selectable selection button may be highlighted. This frees the user from wasting operations and allows the user to efficiently carry out an input operation.

It is noted that exemplified here is an apparatus having a touch-screen operating unit. In the case where the control apparatus 100 has an operating unit of a pointing device, the script may be converted such that a selectable area is not always highlighted;

instead, the selectable area is highlighted only when the pointer is moved on the selectable area.

As described above, in operating an apparatus having a touch-screen operating unit or a pointing-device operating unit, the user has difficulty in telling which selection button is selectable, and would have to go through trial and error to operate the operating unit. As described in the embodiment, previously showing the user a selectable area contributes to promising improvement in the operability of the apparatus. The embodiment also allows an apparatus having a smaller screen to have fewer GUI components each of which appears larger in size, which contributes to promising improvement in the operability and the visibility of the apparatus.

It is noted that a component part (an object) on the operation screen; namely a selection button, with a higher priority assigned to is (i) a selection button which is highlighted by default or (ii) a selection button which is positioned closer to the selection button to be selected. Among the selection buttons, another selection button with a higher priority assigned to may be the one at a position where the user can select the selection button with fewer operational steps. Here, the position where the user can select the selection button with fewer operational steps may be an optional position found in a different hierarchy. Similarly, in the case of the operation screen of a UI utilizing a pointing device, a selection button which is positioned closer to the default position of the pointer has a higher priority assigned to.

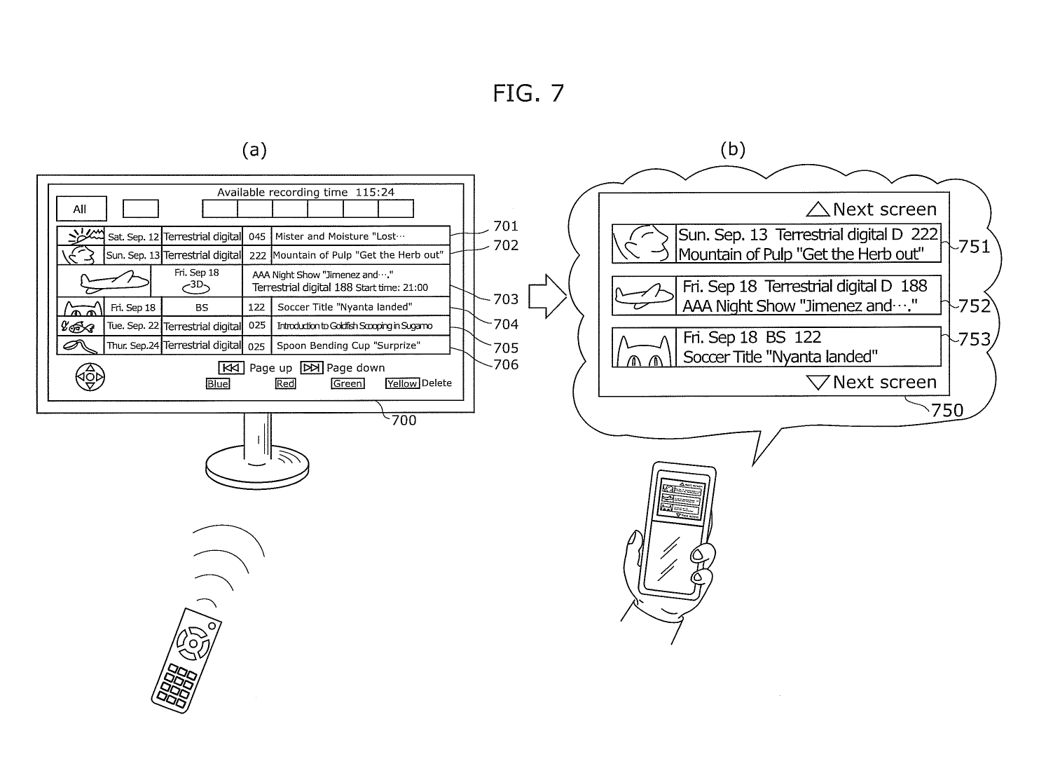

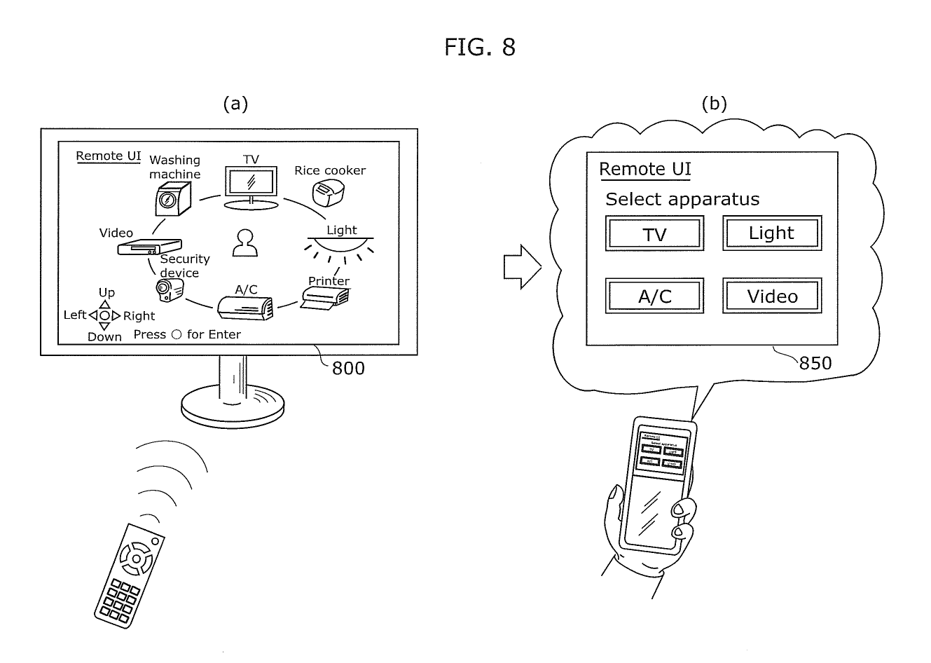

FIG. 7 shows in (a) and (b) an exemplary operation screen before and after script conversion executed to have fewer GUI components when the operation screen displays, as a priority, GUI components closer to the GUI component selected by default. FIG. 8 shows in (a) and (b) an exemplary operation screen before and after script conversion executed to have fewer GUI components when the operation screen displays, as a priority, GUI components found in a criss-cross direction. FIG. 7 shows in (a) an exemplary display showing, on the screen of a TV monitor, a record list of TV programs which are recorded on a digital versatile disc (DVD) recorder. FIG. 7 shows in (b) an exemplary operation screen displaying the record list in (a) in FIG. 7. Here, for example, the record list has received the script conversion and is displayed on the display unit of a cellular phone. A record list 700 in (a) in FIG. 7 displays TV programs recorded on the DVD recorder. For example, the record list 700 in (a) in FIG. 7 displays program information of six TV programs, such as “Mister and Moisture” 701, “Mountain of Pulp” 702, “AAA Night Show” 703, “Soccer Title” 704, “Introduction to Goldfish Scooping” 705, and “Spoon Bending Cup” 706. In the case where the user found a program of his or her desire in the record list, the user selects the information of the desired program and presses enter, so that the DVD recorder reproduces the program. In the record list 700, the program “AAA Night Show” 703 is selected by default. In order to show that the program “AAA Night Show” 703 is selected, the record list 700 shows the information of the program “AAA Night Show” 703 larger than any other program information.

The control apparatus 100 causes the display unit 150, of a cellular phone equipped with a touch-screen input unit, to display the details of the record list 700 as a record list 750. Here, the record list 700 is converted into the record list 750 such that the details of the record list 700 are displayed on the display unit 150 in one screen. According to an operation of the user on the record list 750, the control apparatus 100 causes the DVD recorder to reproduce the desired program. The record list 700 is created landscape-oriented to fit the display area in the viewing area of the TV monitor. Thus, when the control apparatus 100 is a cellular phone, there is too much information to fit on the display area of the display unit 150 that not all the information can be fit in one screen. Thus, the script converting unit 130 carries out the script conversion such that each of the program information items works as a selection button, and that fewer selection buttons are to be displayed, as shown in the record list 750 in (b) in FIG. 7, for example. The record list 750 displays information items of programs “Mountain of Pulp” 751, “AAA Night Show” 752, and “Soccer Title” 753. The script converting unit 130 interprets the script obtained from the DVD recorder, compares the size of the display area of the TV monitor included in the screen information with the size of the display area of the display unit 150 of the cellular phone, and reduces the display of the program information included in the record list 700. Here, the script converting unit adjusts the font size of the characters included in the reduced program information, such that the font size is not smaller than a predetermined font size. In the case where not all of the selection buttons showing the program information items can be fit in one screen even though the record list 700 is reduced, the script converting unit 130 displays the top three selection buttons, assigning the highest priority to the program “AAA Night Show” 703 selected by default. The rest of the selection buttons indicate the program information items that are selectable in the order of having fewer steps from the program information item of the program “AAA Night Show” 703. Furthermore, in the case where the script converting unit 130 reduces the number of the selectable program information items included in the record list 700 to be displayed on the operation screen of the control target apparatus 200, and causes the record list 750 to display the reduced information items, the script converting unit 130 may cause the record list 750 to display a next screen button directing the user to go to a new page showing program information items in the next hierarchy.

FIG. 8 shows in (a) an exemplary display when a menu screen of the remote UI is displayed on the screen of the TV monitor. FIG. 8 shows in (b) an exemplary operation screen displaying the list in (a) in FIG. 8. Here, for example, the list has received the script conversion and is displayed on the display unit of a cellular phone. As shown in (a) in FIG. 8, a menu screen 800 shows, as icons, remote-controllable apparatuses on a TV remote control. Specifically, the menu screen 800 displays icons indicating a TV, a rice cooker, a light, a printer, an air conditioner, a security device, a video, and a washing machine. Such icons are arranged in an oval around an icon of a person. Through the menu screen 800, the user selects an apparatus which he or she desires to remotely control. When the user determines the apparatus, the control screen of the selected apparatus opens. On the control screen, the user can set the timer of the power source of the apparatus, and carry out the setting depending on each of the apparatuses. It is noted that, in the menu screen 800, the person icon is to be selected by default.

The script converting unit 130 obtains a script for displaying the menu screen 800 from the TV, interprets the script, and converts the script such that the menu screen 800 can be displayed on the display unit 150 of the control apparatus 100. Here, eight icons are displayed on the menu screen 800 of the TV. In the case where the script converting unit 130 determines that (i) the control apparatus 100 is a cellular phone equipped with a touch screen and (ii) the touch screen cannot display all the icons in one screen as selection buttons larger than the reference size, the script converting unit 130 extracts, as a higher priority, an icon closer to a criss-cross direction from the person icon, and displays a menu screen 850 on the display unit 150. The person icon shows the default position of the menu screen 800. Here, top four icons are extracted in the descending order of priority, and displayed as selection buttons. As shown in (b) in FIG. 8, the TV, the air conditioner, the light, and the video, which are arranged criss-cross with respect to the person icon on the menu screen 800, are extracted from the script on the menu screen 800, and displayed on the menu screen 850 as selection buttons.

It is noted that the above script conversion is carried out by, for example, JavaScript (Trademark). However, the present invention shall not be limited to JavaScript. Any script is applicable as far as the script is capable of changing some of the parts allocated on the viewing area, as JavaScript does.

In the above embodiment, furthermore, the script converting unit 130 is to be included in the control apparatus 100; however, the present invention shall not be limited to this. The script converting unit 130 may be included in the control target apparatus 200. Here, the control apparatus 100 transmits, to the control target apparatus 200, the apparatus ID of the control apparatus 100 to start remote UI. Before the script conversion, the control target apparatus 200 requests, via an IP communication path, the apparatus specifications obtaining unit 140 in the control apparatus 100 to inquire about the information on the display unit 150 and the operating unit 160. In response to the request of the inquiry from the control target apparatus 200, the apparatus specifications obtaining unit 140 sends inquiries to the display unit 150 and the operating unit 160. Then, through the communications unit 101 and the communication path 3, the apparatus specifications obtaining unit 140 sends the control target apparatus 200 the inquiry result; that is the information on the display unit 150 and the operating unit 160. Moreover, the script receiving unit 120 receives the converted script from the control target apparatus 200, and forwards the script to the script executing unit 121. The script executing unit 121 executes the script received from the script receiving unit 120 in order to transmit a command corresponding to an operated selection button to the command receiving unit 221 in the control target apparatus 200.

Here, before the script conversion, the control target apparatus 200 does not necessarily request the apparatus specifications obtaining unit 140 in the control apparatus 100 to inquire about the information on the display unit 150 and the operating unit 160. For each of apparatuses to be designated as the control apparatus 100, for example, the control target apparatus 200 may previously store, in the memory, information on the display unit 150 and the operating unit 160 in the control apparatus 100 in association with the apparatus ID of the apparatus. This feature allows the control target apparatus 200 to read the information on the display unit 150 and the operating unit 160 from the memory and carry out the script conversion, eliminating the need for sending an inquiry to the control apparatus 100.

As described above, the embodiment makes it possible to provide an optimum screen display which suits the display capability and the operation procedure of a control target apparatus even though the control apparatus and the control target apparatus, expected to have high demand, differ with each other in display the capability and the operation procedure. Accordingly, the user can remotely control the control target apparatus without losing an operational feeling.

It is noted that in the embodiment, the TV 300 is connected with the control target apparatus 200 via HDMI; meanwhile, the TV 300 may be connected via the communication path 3.

It is noted that each of the functional blocks in the block diagrams (FIGS. 2 and 3) is typically provided in a form of a Large-Scale Integration (LSI); namely, an integrated circuit. The functional blocks may be made as separate individual chips, or as a single chip to include part or all thereof.

For example, the functional blocks other than the memory may be made in a single chip.

Here, the functional blocks are referred to as LSI; however, the functional blocks may also be referred to as IC, LSI, super LSI, and ultra LSI, due to a difference in the degree of integration.

Furthermore, the means for circuit integration is not limited to an LSI, and implementation in the form of a dedicated circuit or a general-purpose processor is also available. In addition, it is also acceptable to use a Field Programmable Gate Array (FPGA) that is programmable after the LSI has been manufactured, and a reconfigurable processor in which connections and settings of circuit cells within the LSI are reconfigurable.

Furthermore, if integrated circuit technology that replaces LSI appears thorough progress in semiconductor technology or other derived technology, that technology can naturally be used to carry out integration of the functional blocks. Biotechnology can be applied to the integrated circuit technology.

Moreover, among the functional blocks, a unit storing content may be formed in a different part, instead of being included in a single chip.

Although only an exemplary embodiment of the present invention has been described in detail above, those skilled in the art will readily appreciate that many modifications are possible in the exemplary embodiment without materially departing from the novel teachings and advantages of the present invention. Accordingly, all such modifications are intended to be included within the scope of the present invention

### INDUSTRIAL APPLICABILITY

A control apparatus of the present invention is useful as an apparatus for remote UI. In particular, the control apparatus is useful for a cellular phone equipped with a touch-screen control unit, and for a mobile device such as Personal Digital Assistants (PDAs). Moreover, a control target apparatus of the present invention is useful for an apparatus for remote UI. In particular, the control target apparatus is useful as a TV displaying information on a large monitor, and a DVD recorder.

What is claimed is:

1. A control apparatus comprising:
an obtaining unit configured to obtain screen display operational information on a control target apparatus;
an operating unit configured to receive an input from a user;
a converting unit configured to convert the screen display operational information such that the screen display operational information conforms to an input method of said operating unit; and
a display unit configured to display a screen formed based on the converted screen display operational information.

2. The control apparatus according to claim 1,
wherein, among graphical user interface (GUI) components allocated on the screen formed based on the screen display operational information that has not been converted, said converting unit is configured to highlight a selectable GUI component such that the highlighted selectable GUI component conforms to the input method.

3. The control apparatus according to claim 2,
wherein, when the input method is either a touch-screen style or a pointing-device style, said converting unit is configured to highlight a button which is the selectable GUI component.

4. The control apparatus according to claim 2,
wherein, when the input method is a pointing-device style, said converting unit is configured to highlight a button which is the selectable GUI component when a pointer is moved on the button.

5. The control apparatus according to claim 2,
wherein, when the input method is a touch-screen style, said converting unit is configured to enlarge a display size of a button which is the selectable GUI component.

6. The control apparatus according to claim 2,
wherein said converting unit is configured to determine whether or not the screen, formed based on the screen display operational information, can fit to said display unit in one screen, and
in the case where the determination result shows that the screen cannot fit in one screen, said converting unit is configured to convert the screen display operational information such that selectable GUI components including the selectable GUI component decrease in number, the selectable GUI components being allocated on the screen formed based on the screen display operational information that has not been converted.

7. The control apparatus according to claim 6,
wherein, in the case where the determination result shows that the screen cannot fit in one screen, said converting unit is configured to display the predetermined number of the selectable GUI components in a descending order of predetermined priority, the selectable GUI components being allocated on the screen formed based on the screen display operational information.

8. A control apparatus comprising:
an obtaining unit configured to obtain screen display operational information on a control target apparatus;
an operating unit configured to receive an input from a user;
a converting unit configured to convert the screen display operational information according to a kind of a GUI component allocated on a screen formed based on the screen display operational information; and
a display unit configured to display the screen formed based on the converted screen display operational information.

9. A control apparatus comprising:
an obtaining unit configured to obtain screen display operational information on a control target apparatus;
an operating unit configured to receive an input from a user;
a converting unit configured to convert the screen display operational information; and
a display unit configured to display a screen formed based on the converted screen display operational information,
wherein said converting unit is configured to convert the screen display operational information such that the screen display operational information conforms to a display aspect ratio of said display unit.

10. The control apparatus according to claim 8,
wherein said converting unit is configured to determine whether or not the screen, formed based on the converted screen display operational information, can fit to said display unit in one screen, and
in the case where the determination result shows that the screen cannot fit in one screen, said converting unit is configured to decreases selectable GUI components including the GUI component and allocated on the converted screen display operational information.

11. The control apparatus according to claim 10,
wherein, in the case where the determination result shows that the screen cannot fit in one screen, said converting unit is configured to display the predetermined number of the selectable GUI components in a descending order of predetermined priority, the selectable GUI components being allocated on the screen formed based on the screen display operational information.

12. A script converting method comprising:
obtaining screen display operational information on a target apparatus;
receiving an input from a user;
converting the screen display operational information such that the screen display operational information conforms to an input method of the user; and
displaying a screen formed based on the converted screen display operational information.

13. A control system comprising:
a control apparatus; and
a control target apparatus,
wherein said control apparatus includes:
an obtaining unit configured to obtain screen display operational information on a control target apparatus;
an operating unit configured to receive an input from a user;
a converting unit configured to convert the screen display operational information such that the screen display operational information conforms to an input method of said operating unit;
a display unit configured to display a screen formed based on the converted screen display operational information; and
a command transmitting unit configured to transmit, to said target unit, a command corresponding to the input from the user to the operating unit, and
said control target apparatus is configured to operate according to the command received from said control apparatus.

14. A non-transitory computer-readable recording medium on which a computer program is recorded, the program causing a computer to operate as:
an obtaining unit configured to obtain screen display operational information on a control target apparatus;
an operating unit configured to receive an input from a user;
a converting unit configured to convert the screen display operational information such that the screen display operational information conforms to an input method of said operating unit; and
a display unit configured to display a screen formed based on the converted screen display operational information.
